(19) United States
(12) Patent Application Publication
(10) Pub. No.: US 2025/0217497 A1
(43) Pub. Date: Jul. 3, 2025

(54) INFORMATION PROCESSING APPARATUS, INFORMATION PROCESSING METHOD, AND COMPUTER-READABLE RECORDING MEDIUM

(71) Applicant: NEC Corporation, Minato-ku, Tokyo (JP)

(72) Inventors: Jun KODAMA, Tokyo (JP); Junpei KAMIMURA, Tokyo (JP); Kazuhiko ISOYAMA, Tokyo (JP); Shun MIYAZAKI, Tokyo (JP)

(73) Assignee: NEC Corporation, Minato-ku, Tokyo (JP)

(21) Appl. No.: 18/851,302

(22) PCT Filed: Mar. 30, 2022
(86) PCT No.: PCT/JP2022/015928

§ 371 Date: Sep. 26, 2024

(51) Int. Cl. G06F 21/57

(52) U.S. Cl. CPC G06F 21/577

(57) ABSTRACT

An information processing apparatus includes: a policy analysis unit that analyzes a security policy of operation of a target system; a dataflow information analysis unit that analyzes dataflow information of the target system; and an operation procedure construction unit that searches operation procedures registered in advance, using a result of analysis of the security policy, to specify a corresponding operation procedure, and applies a result of analysis of the dataflow information to the specified operation procedure to construct an operation procedure of the target system.

### TECHNICAL FIELD

The present invention relates to an information processing apparatus and an information processing method that support the construction of a computer system, and further relates to a computer-readable recording medium having recorded thereon a program for realizing the apparatus and method.

### BACKGROUND ART

Many computer systems are connected externally by networks and are constantly exposed to external threats. Companies are thus required to optimize the operation and maintenance of computer systems.

In response to this, Patent Document 1 discloses an apparatus that supports the operation and maintenance of computer systems. The apparatus disclosed in Patent Document 1 visualizes a network in a computer system and models the visualized network. The apparatus disclosed in Patent Document 1 then executes simulation using the modeled network, and thereby performs network path detection and failure diagnosis. Accordingly, operation and maintenance of a computer system by an administrator will be supported in the case where the apparatus disclosed in Patent Document 1 is introduced.

Patent Document 2 discloses an apparatus for automatically creating dataflow information of a computer system. The apparatus disclosed in Patent Document 2 generates job flow diagrams and dataflow information of the computer system, based on JCL (Job Control Language) analysis information, program analysis information, jobnet information, and utility information. With the apparatus disclosed in Patent Document 2, the administrator is able to grasp the overall system, and to easily grasp places that need to be modified in the case of reconstructing the system. Operation and maintenance of a computer system by an administrator will also be supported in the case where the apparatus disclosed in Patent Document 2 is introduced.

### LIST OF RELATED ART DOCUMENTS

### Patent Document

Patent Document 1: Japanese Patent Publication No. 2017-506843
Patent Document 1: Japanese Patent Laid-Open Publication No. JP 2003-67186A

### SUMMARY OF INVENTION

### Problems to be Solved by the Invention

In recent years, IT technology has been developing at an accelerated pace, and computer systems are becoming more and more complex. Thus, companies configure a security policy and carry out construction, operation, and maintenance of the computer system in line with the security policy.

However, with the apparatuses disclosed in Patent Documents 1 and 2 described above, security policies are not taken into consideration at all, thus making it impossible to support construction of a computer system that is in line with a security policy.

An example object of the present invention is to provide an information processing apparatus, an information processing method, and a computer-readable recording medium that can support construction of a computer system by presenting a configuration procedure that is in line with a security policy.

### Means for Solving the Problems

In order to achieve the above-described object, an information processing apparatus according to an example aspect of the present invention includes:
a policy analysis unit that analyzes a security policy of operation of a target system;
a dataflow information analysis unit that analyzes dataflow information of the target system; and
an operation procedure construction unit that searches operation procedures registered in advance, using a result of analysis of the security policy, to specify a corresponding operation procedure, and applies a result of analysis of the dataflow information to the specified operation procedure to construct an operation procedure of the target system.

In order to achieve the above-described object, an information processing method according to an example aspect of the present invention includes:
analyzing a security policy of operation of a target system;
analyzing dataflow information of the target system; and
searching operation procedures registered in advance, using a result of analysis of the security policy, to specify a corresponding operation procedure, and applying a result of analysis of the dataflow information to the specified operation procedure to construct an operation procedure of the target system.

In order to achieve the above-described object, a computer readable recording medium according to an example aspect of the present invention is a computer readable recording medium that includes recorded thereon a program,
analyzing a security policy of operation of a target system;
analyzing dataflow information of the target system; and
searching operation procedures registered in advance, using a result of analysis of the security policy, to specify a corresponding operation procedure, and applying a result of analysis of the dataflow information to the specified operation procedure to construct an operation procedure of the target system.

### Advantageous Effects of the Invention

As described above, according to the present invention, it is possible to support construction of a computer system by presenting a configuration procedure that is in line with a security policy.

### BRIEF DESCRIPTION OF THE DRAWINGS

FIG. 1 is a block diagram illustrating a schematic configuration of the information processing apparatus of the first example embodiment.

FIG. 2 is a diagram illustrating an example of processing in the information processing apparatus.

FIG. 3 is a diagram illustrating another example of processing in the information processing apparatus.

FIG. 4 is a flow diagram illustrating operations of the information processing apparatus of the first example embodiment.

FIG. 5 is a block diagram illustrating the configuration of the information processing apparatus of the second example embodiment.

FIG. 6 shows examples of operation policies that are used in the second example embodiment.

FIG. 7 is a flow diagram illustrating operations of the information processing apparatus of the second example embodiment.

FIG. 8 is a block diagram illustrating an example of a computer that realizes the information processing apparatus according to the first and second example embodiment.

### EXAMPLE EMBODIMENTS

### First Example Embodiment

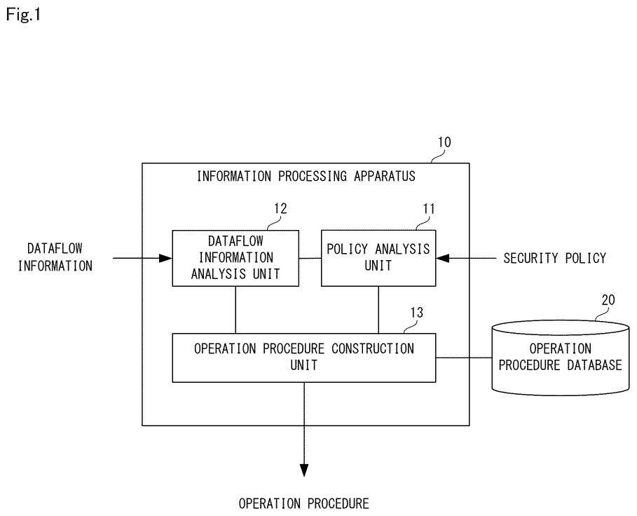

Hereinafter, an information processing apparatus, an information processing method, and a program of a first example embodiment will be described with reference to FIGS. 1 to 4.

### Apparatus Configuration

Initially, a schematic configuration of the information processing apparatus of the first example embodiment will be described using FIG. 1. FIG. 1 is a block diagram illustrating a schematic configuration of the information processing apparatus of the first example embodiment.

An information processing apparatus 10 of the first example embodiment illustrated in FIG. 1 is an apparatus that supports construction of a computer system that is in line with a security policy. As illustrated in FIG. 1, the information processing apparatus 10 includes a policy analysis unit 11, a dataflow information analysis unit 12, and an operation procedure construction unit 13.

The policy analysis unit 11 analyzes the security policy of operation of a target system. The dataflow information analysis unit 12 analyzes dataflow information of the target system.

The operation procedure construction unit 13, first, searches operation procedures registered in advance, using the result of analysis of the security policy, and specifies a corresponding operation procedure. Next, the operation procedure construction unit 13 applies the result of analysis of the dataflow information by the dataflow information analysis unit 12 to the specified operation procedure and constructs an operation procedure of the target system.

In this way, the information processing apparatus 10 constructs an optimal operation procedure for the system from an operation procedure that is in line with a security policy and dataflow information of the target system. The information processing apparatus 10 is thus able to support construction of a computer system, by presenting the user with a configuration procedure that is in line with the security policy.

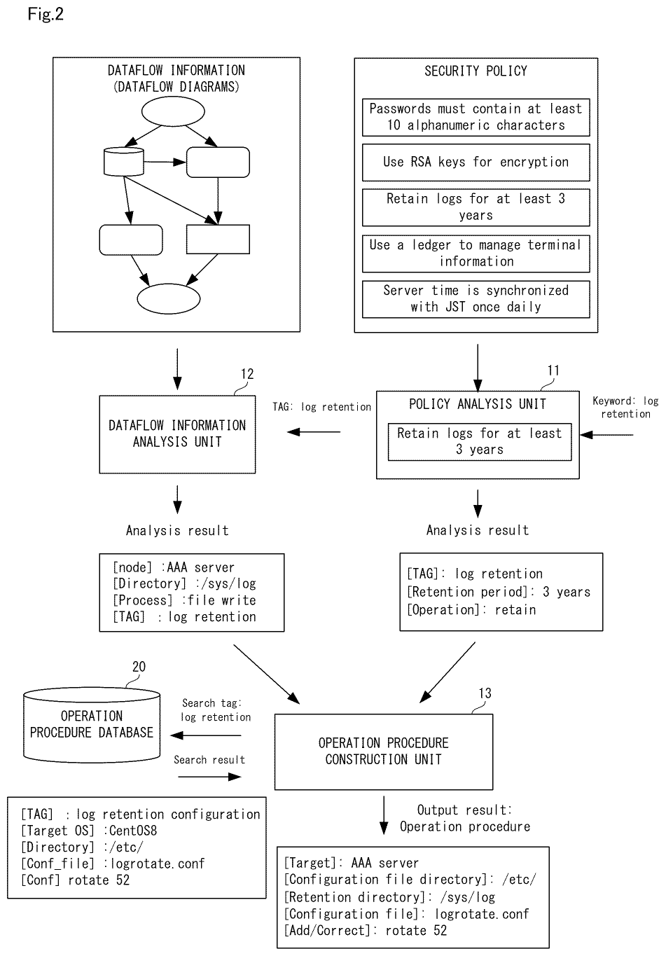

Next, the configuration and functions of the information processing apparatus 10 of the first example embodiment will be described more specifically. First, as illustrated in FIG. 2, in the first example embodiment, operation procedures are registered in a database (hereinafter referred to as “operation procedure database”) 20. The information processing apparatus 10 is connected to the operation procedure database 20 in a data communicable manner via a network or the like.

First, security policies are configured in advance by an organization that operates the target system, or the like, and stored in a database or the like. Examples of security policies include “passwords must contain at least 10 alphanumeric characters”, “use RSA keys for encryption”, “retain logs for at least 3 years”, and “use a ledger to manage terminal information”.

A plurality of security policies are configured and categorized in advance by tags. The user of the information processing apparatus 10 is thus able to designate a security policy he or she wants to confirm from among the plurality of security policies. The user designates a security policy by, for example, entering keywords such as “password setting”, “encryption”, and “log retention”.

In the first example embodiment, the policy analysis unit 11 initially receives designation of a security policy by the user. The policy analysis unit 11 then extracts information relating to the security policy designated by the user, from among the plurality of security policies. Specifically, the policy analysis unit 11 receives keywords entered by the user, searches the plurality of security policies, based on the received keywords, and specifies a security policy corresponding to the keywords. The policy analysis unit 11 then extracts information of the designated security policy, such as a tag that is configured and parameters associated with the tag, for example.

In the first example embodiment, the dataflow information analysis unit 12 extracts, from dataflow information of the target system, information related to the information extracted as analysis of the security policy by the policy analysis unit 11.

Specifically, dataflow information is information for constructing dataflow diagrams. Dataflow diagrams represent the flow of data in a system as a graph and are used in order to design and analyze the structure of the system. Dataflow diagrams are hierarchically generated according to the use purpose of the system. Dataflow diagrams are, for example, generated by using a technology disclosed in the following reference. Dataflow diagrams may also be created manually.

Reference: Shun MIYAZAKI and Junpei KAMIMURA, “Automation of Security Vulnerability Analysis by Auto-generated DFD”, IEICE Technical Report, vol. 121, no. 275, ICSS2021-48, pp. 13-18, November 2021

A plurality of dataflow diagrams are created, similarly to the security policies, and the dataflow diagrams are categorized by tags. Similarly, the dataflow information is also categorized by tags. Thus, the dataflow information analysis unit 12, first, specifies dataflow information to be analyzed, using the tag output by the policy analysis unit 11. The policy analysis unit 11 then extracts, from the specified dataflow information, information such as location, operation, process, and tag, as a result of analysis of the dataflow information.

In the first example embodiment, the operation procedure database 20 registers and stores an operation procedure for each tag. An example of an operation procedure is “add “/sys/log/auth.log rotate 52” to end of/etc/logrotate.conf file of A server” for a tag “log retention”. Another example of an operation procedure is “create cron.conf file containing “0 30/etc/inet/ntpd-b NTPserver” on A server and execute command “crontab cron.conf” on A server” for a tag “time synchronization configuration”.

In the first example embodiment, the operation procedure construction unit 13 searches the operation procedure database 20, using the information extracted from the security policies, and specifies a corresponding operation procedure. Specifically, the operation procedure construction unit 13 searches the operation procedure database 20, using the tag output by the policy analysis unit 11. An operation procedure that corresponds to the tag is thereby specified.

Next, the operation procedure construction unit 13 integrates the specified operation procedure and the information extracted from the dataflow information to construct a final operation procedure of the target system. Specifically, the operation procedure construction unit 13 integrates a device name such as a specific server name extracted from the dataflow information into the operation procedure retrieved from the operation procedure database 20. Thereafter, the operation procedure construction unit 13 outputs the resultant operation procedure.

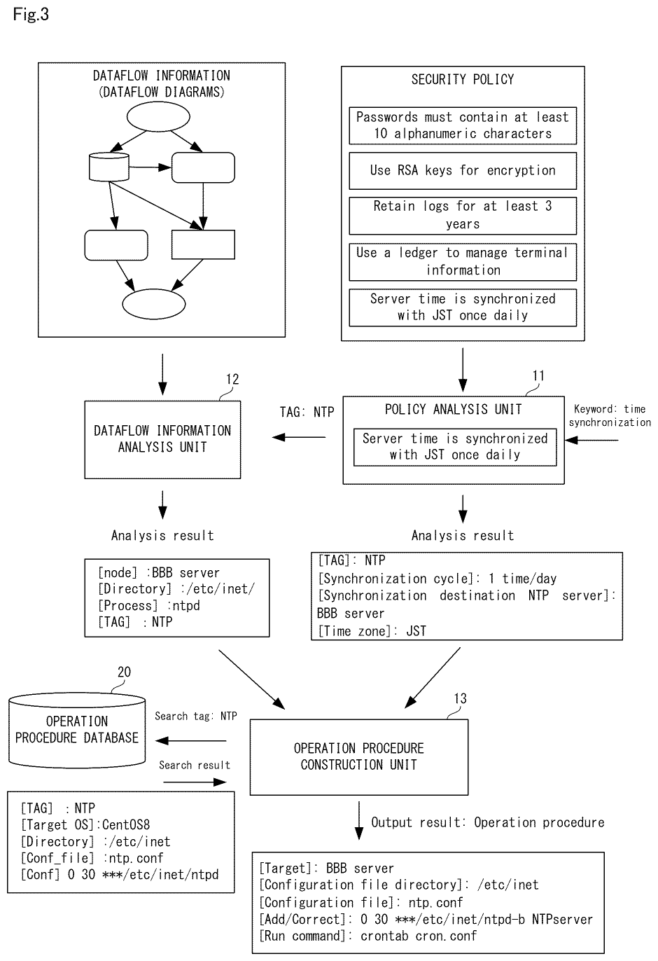

Here, a specific example of processing in the information processing apparatus 10 will be described, using FIGS. 2 and 3. FIG. 2 is a diagram illustrating an example of processing in the information processing apparatus. FIG. 3 is a diagram illustrating another example of processing in the information processing apparatus.

In the example in FIG. 2, the user inputs the keywords “log retention”, and thus the policy analysis unit 11 specifies a security policy “retain logs for at least 3 years” corresponding to these keywords. Also, the policy analysis unit 11 extracts a tag “log retention” of the specified security policy and parameters “retention period: 3 years” and “operation: retain” associated with the tag.

Also, in the example in FIG. 2, the dataflow information analysis unit 12 specifies dataflow information to be analyzed, using the tag “log retention” output by the policy analysis unit 11. The dataflow information analysis unit 12 then extracts “[node]: AAA server”, “[Directory]: /sys/log”, “[Process]: file write”, “[TAG]: log retention” from the specified dataflow information.

Furthermore, in the example in FIG. 2, the operation procedure construction unit 13 searches the operation procedure database 20, using the tag “log retention” output by the policy analysis unit 11. The operation procedure construction unit 13 thereby extracts “[TAG]: log retention configuration”, “[Target OS]: CentOS8”, “[Directory]: /etc/”, “[Conf_file]: logrotate.conf” and “[Conf]: rotate 52” as an operation procedure corresponding to the tag.

Next, the operation procedure construction unit 13 adds “[node]: AAA server” and “[Directory]: /sys/log” from the information extracted from the dataflow information to the specified operation procedure. The operation procedure construction unit 13 then outputs “[Target]: AAA server”, “[Configuration file directory]: /etc/”, “[Retention directory]: /sys/log”, “[Configuration file]: logrotate.conf”, and “[Add/Correct]: rotate 52” as an operation procedure of the target system.

In the example in FIG. 3, the user inputs the keywords “time synchronization”, and thus the policy analysis unit 11 specifies a security policy “server time is synchronized with JST (Japan Standard Time) once daily” corresponding to these keywords. Also, the policy analysis unit 11 extracts a tag “NTP (time synchronization)” of the specified security policy and parameters “synchronization cycle: 1 time/day”, “synchronization destination NTP server: BBB server” and “time zone: JST” associated with the tag.

Also, in the example in FIG. 3, the dataflow information analysis unit 12 specifies dataflow information to be analyzed, using the tag “NTP” output by the policy analysis unit 11. The dataflow information analysis unit 12 then extracts “[node]: BBB server”, “[Directory]: /etc/inet/”, “[Process]: ntpd”, “[TAG]: NTP” from the specified dataflow information.

Furthermore, in the example in FIG. 3, the operation procedure construction unit 13 searches the operation procedure database, using the tag “NTP” output by the policy analysis unit 11. The operation procedure construction unit 13 thereby extracts “[TAG]: NTP”, “[Target OS]: CentOS8”, “[Directory]: /etc/inet”, “[Conf_file]: ntp.conf” and “[Conf]: 0 30 ***/etc/inet/ntpd” as an operation procedure corresponding to the tag.

Next, the operation procedure construction unit 13 adds “[node]: BBB server” from the information extracted from the dataflow information to the specified operation procedure. The operation procedure construction unit 13 then outputs “[Target]: BBB server”, “[Configuration file directory]: /etc/inet”, “[Configuration file]: ”, “[Add/Correct]: 0 30 ***/etc/inet/ntpd-b NTPserver” and “Run command: “crontab cron.conf”” as an operation procedure of the target system.

### Apparatus Operations

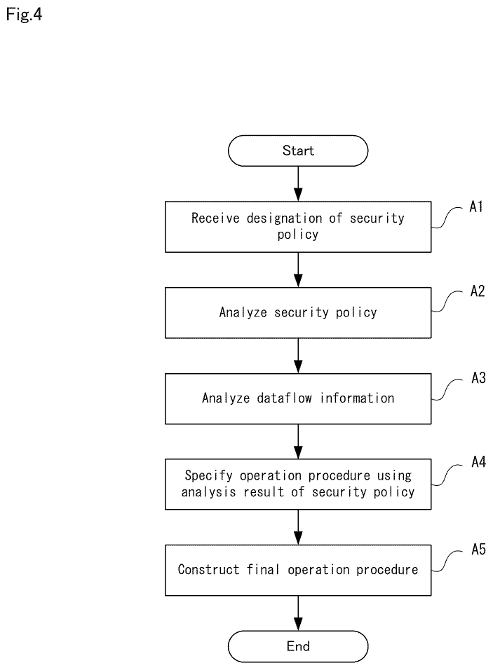

Next, operations of the information processing apparatus 10 of the first example embodiment will be described using FIG. 4. FIG. 4 is a flow diagram illustrating operations of the information processing apparatus of the first example embodiment. In the following description, FIGS. 1 to 3 will be referred to as appropriate. Also, in the first example embodiment, an information processing method is implemented by operating the information processing apparatus 10. Therefore, description of the information processing method of the first example embodiment is replaced by the following description of the operations of the information processing apparatus 10.

As illustrated in FIG. 4, initially, the policy analysis unit 11 receives designation of a security policy by the user (step A1). Specifically, the user designates a security policy by entering keywords.

Next, the policy analysis unit 11 analyzes the security policy designated by the user, by extracting information relating to the designated security policy from among a plurality of security policies set in advance (step A2). Examples of extracted information include a tag assigned to the security policy and parameters associated with the tag.

Next, the dataflow information analysis unit 12 analyzes dataflow information, by extracting information related to the information extracted in step A2 from dataflow information of the target system (step A3). Specifically, the dataflow information analysis unit 12 specifies dataflow information to be analyzed, using the tag extracted in step A2, and extracts information such as location, operation, process, and tag from the specified dataflow information.

Next, the operation procedure construction unit 13 searches the operation procedure database 20, using the information extracted from the security policies by the analysis in step A2, and specifies a corresponding operation procedure (step A4). Specifically, the operation procedure construction unit 13 searches the operation procedure database 20, using the tag extracted in step A2. An operation procedure that corresponds to the tag is thereby specified.

Next, the operation procedure construction unit 13 integrates the operation procedure specified in step A4 and the information extracted in step A3 to construct an operation procedure of the target system (step A5). Specifically, the operation procedure construction unit 13 constructs an operation procedure of the target system, by integrating a device name such as a specific server name extracted from the dataflow information into the operation procedure retrieved by step A4.

The operation procedure construction unit 13 outputs the constructed operation procedure to an external display device or to a terminal device of the user. The user is thereby able to confirm the constructed operation procedure.

As described above, in the first example embodiment, an operation procedure of the target system is constructed, by integrating an operation procedure that is in line with a security policy with dataflow information of the target system. The user is thus able to easily construct a computer system that is in line with the security policy, by confirming the constructed operation procedure.

### Program

A program of the first example embodiment may be any program that causes a computer to execute steps A1 to A5 illustrated in FIG. 4. The information processing apparatus 10 and the information processing method of the first example embodiment can be realized, by this program being installed in a computer and executed. In this case, a processor of the computer performs processing by functioning as the policy analysis unit 11, the dataflow information analysis unit 12, and the operation procedure construction unit 13. Examples of the computer include a general-purpose PC as well as a smartphone and a tablet-type terminal device.

The program of the first example embodiment may be executed by a computer system constructed from a plurality of computers. In this case, for example, the computers may each function as one of the policy analysis unit 11, the dataflow information analysis unit 12, and the operation procedure construction unit 13.

### Second Example Embodiment

Next, an information processing apparatus, an information processing method, and a program of a second example embodiment will be described with reference to the drawings.

### Apparatus Configuration

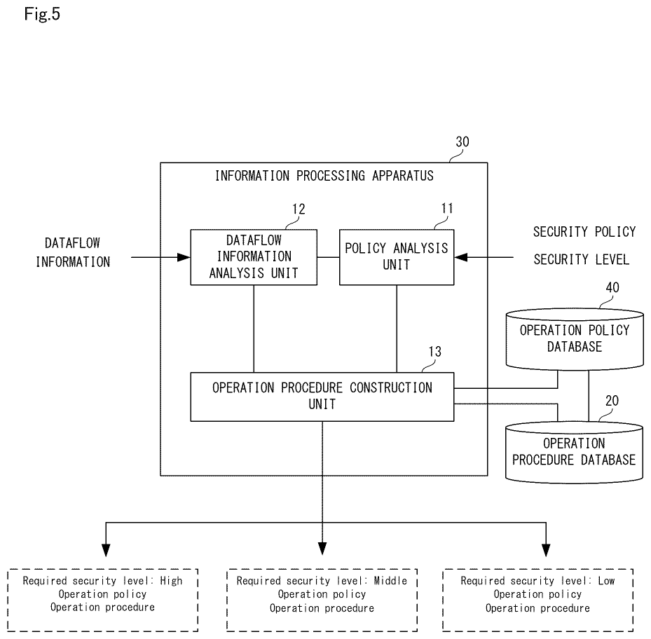

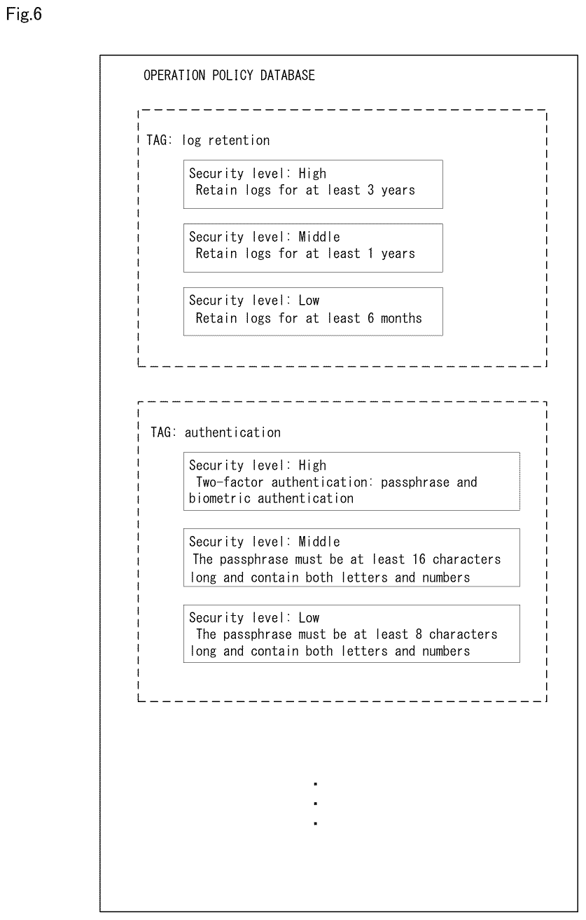

First, a configuration of the information processing apparatus of to the second example embodiment will be described using FIGS. 5 and 6. FIG. 5 is a block diagram illustrating the configuration of the information processing apparatus of the second example embodiment.

An information processing apparatus 30 of the second example embodiment illustrated in FIG. 5 is also an apparatus that supports the construction of a computer system that is in line with a security policy, similarly to the information processing apparatus 10 of the first example embodiment. As illustrated in FIG. 5, the information processing apparatus 30 also includes a policy analysis unit 11, a dataflow information analysis unit 12, and an operation procedure construction unit 13, similarly to the information processing apparatus 10.

However, the second example embodiment differs from the first example embodiment in terms of the function of the operation procedure construction unit 13. In the second example embodiment, the operation procedure construction unit 13, first, determines an operation policy of the target system, using information extracted from the security policies.

The operation procedure construction unit 13 then searches operation procedures registered in advance, using the determined operation policy, and specifies an operation procedure corresponding to a designated security policy. The operation procedure construction unit 13 then also integrates the determined operation policy in addition to the operation procedure and the information extracted from the dataflow information to construct an operation procedure of the target system. The following description focuses on the differences from the first example embodiment.

As illustrated in FIG. 5, in the second example embodiment, the information processing apparatus 30 is also connected to an operation policy database 40 in a data communicable manner via a network or the like, in addition to an operation procedure database 20.

The operation policy database 40 registers and stores an operation policy for each tag. Also, the operational policy includes information indicating the level of security required by the system. Specific examples of operation policies will be described using FIG. 6. FIG. 6 shows examples of operation policies that are used in the second example embodiment.

In the example in FIG. 6, the operation policy database 40 registers an operation policy for each tag. Also, an operation policy for each tag is further set for each security level. Note that, in the example in FIG. 6, there are three security levels “high”, “medium”, and “low”, but, in the second example embodiment, the method of setting the security level is not limited thereto.

The operation procedure construction unit 13, first, searches the operation policy database 40, using information extracted from the security policies, specifically, the tag “log retention” output by the policy analysis unit 11, and determines an operation policy of the target system.

In the second example embodiment, each operation procedure stored in the operation procedure database 20 is linked to one of the operation policies. Operation procedures may be linked to operation policies by the above-described tags, or by assigning an identifier of the corresponding operation policy to each operation procedure. Furthermore, as illustrated in the example in FIG. 6, when the above-described security levels are set for the operation policies, the operation procedures may be linked for each security level. Also, a plurality of operation procedures may be linked to one operation policy.

In this way, the operation procedures are linked to operation policies, and thus the operation procedure construction unit 13, upon determining an operation policy, searches the operation procedure database 20, using the determined operation policy, and specifies an operation procedure linked to the determined operation policy.

The operation procedure construction unit 13 then integrates a device name such as a specific server name extracted from the dataflow information into the operation procedure retrieved from the operation procedure database 20, and also integrates the operation policy used in the search to construct a final operation procedure. Thereafter, the operation procedure construction unit 13 outputs the resultant operation procedure as illustrated in FIG. 5. In the example in FIG. 5, the above-described security levels are set for the operation policies, and thus an operation policy and an operation procedure are output for each security level.

In the second example embodiment, the policy analysis unit 11 is also able to receive designation of a security level by the user, in addition to designation of a security policy by the user. In this case, the policy analysis unit 11 notifies the operation procedure construction unit 13 of the received security level, and the operation procedure construction unit 13 determines an operation policy corresponding to the notified security level. Also, the operation procedure construction unit 13 outputs the operation policy and operation procedure corresponding to the notified security level.

### Apparatus Operations

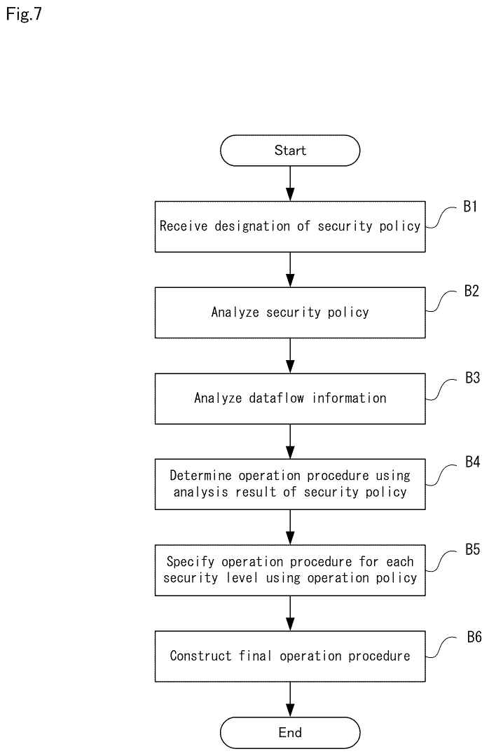

Next, operations of the information processing apparatus 30 of the second example embodiment will be described using FIG. 7. FIG. 7 is a flow diagram illustrating operations of the information processing apparatus of the second example embodiment. In the following description, FIGS. 5 and 6 will be referred to as appropriate. Also, in the second example embodiment, an information processing method is implemented by operating the information processing apparatus 30. Therefore, description of the information processing method of the second example embodiment is replaced by the following description of the operations of the information processing apparatus 30.

As illustrated in FIG. 7, initially, the policy analysis unit 11 receives designation of a security policy by the user (step B1). Step B1 is similar to step A1 illustrated in FIG. 4.

Next, the policy analysis unit 11 analyzes the security policy designated by the user, by extracting information relating to the designated security policy from among a plurality of security policies set in advance (step B2). Step B2 is similar to step A2 illustrated in FIG. 4. The policy analysis unit 11 extracts a tag assigned to the security policy and parameters associated with the tag, for example.

Next, the dataflow information analysis unit 12 analyzes dataflow information, by extracting information related to the information extracted in step B2 from dataflow information of the target system (step B3). Step B3 is similar to step A3 illustrated in FIG. 4. The dataflow information analysis unit 12 extracts information such as location, operation, process, and tag from the dataflow information.

Next, the operation procedure construction unit 13 determines an operation policy of the target system, using information extracted from the security policies by the analysis in step B2 (step B4). Specifically, in step B4, the operation procedure construction unit 13 searches the operation policy database 40, using the tag extracted in step B2 and determines an operation policy of the target system.

Next, the operation procedure construction unit 13 searches the operation procedure database 20, using the operation policy determined in step B4, and specifies, for each security level, an operation procedure linked to the determined operation policy (step B5). The operation procedures thus specified are operation procedures corresponding to the security policy designated in step B1.

Next, the operation procedure construction unit 13 integrates the operation policy determined in step B4, the operation procedure for each security level specified in step B5, and the information extracted in step A3 to construct operation procedures for the target system (step B6). Specifically, the operation procedure construction unit 13 integrates a device name such as a specific server name extracted from the dataflow information into the operation procedure for each security level, and further adds the operation policy determined in step B4 to construct operation procedures of the target system.

The operation procedure construction unit 13 outputs the constructed operation procedures to an external display device or to a terminal device of the user. The user is thereby able to confirm the constructed operation procedures.

As described above, in the second example embodiment, an operation procedure of the target system is constructed, by integrating an operation policy that is in line with a security policy, an operation procedure corresponding thereto, and dataflow information of the target system. The user is thus able to easily construct a computer system that is in line with the security policy, by confirming the constructed operation procedure. Also, in the second example embodiment, since an operation procedure is constructed for each security level, the user is able to easily adapt the computer system to the required security level.

### Program

A program of the second example embodiment may be any program that causes a computer to execute steps B1 to B7 illustrated in FIG. 7. The information processing apparatus 30 and the information processing method of the second example embodiment can be realized, by this program being installed in a computer and executed. In this case, a processor of the computer performs processing by functioning as the policy analysis unit 11, the dataflow information analysis unit 12, and the operation procedure construction unit 13. Examples of the computer include a general-purpose PC as well as a smartphone and a tablet-type terminal device.

The program of the second example embodiment may be executed by a computer system constructed from a plurality of computers. In this case, for example, the computers may each function as one of the policy analysis unit 11, the dataflow information analysis unit 12, and the operation procedure construction unit 13.

### Physical Configuration

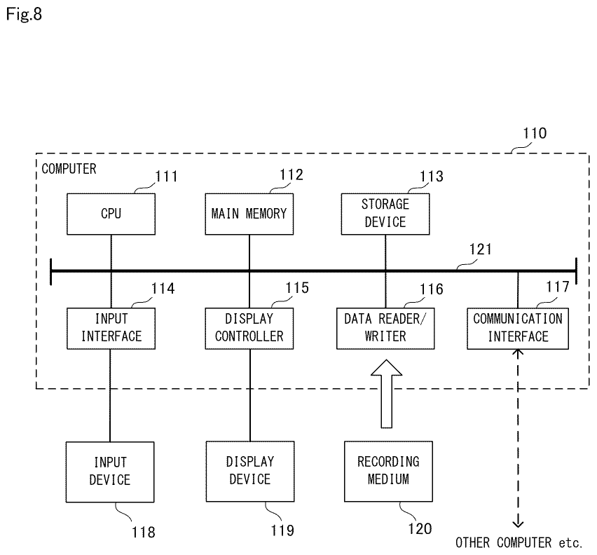

Using FIG. 8, the following describes a computer that realizes the information processing apparatus by executing the program according to the first and second example embodiment. FIG. 8 is a block diagram illustrating an example of a computer that realizes the information processing apparatus according to the first and second example embodiment.

As illustrated in FIG. 8, a computer 110 includes a CPU (Central Processing Unit) 111, a main memory 112, a storage device 113, an input interface 114, a display controller 115, a data reader/writer 116, and a communication interface 117. These components are connected in such a manner that they can perform data communication with one another via a bus 121.

The computer 110 may include a GPU (Graphics Processing Unit) or an FPGA (Field-Programmable Gate Array) in addition to the CPU 111, or in place of the CPU 111. In this case, the GPU or the FPGA can execute the program according to the example embodiment.

The CPU 111 deploys the program according to the example embodiment, which is composed of a code group stored in the storage device 113 to the main memory 112, and carries out various types of calculation by executing the codes in a predetermined order. The main memory 112 is typically a volatile storage device, such as a DRAM (dynamic random-access memory).

Also, the program according to the example embodiment is provided in a state where it is stored in a computer-readable recording medium 120. Note that the program according to the first and second example embodiment may be distributed over the Internet connected via the communication interface 117.

Also, specific examples of the storage device 113 include a hard disk drive and a semiconductor storage device, such as a flash memory. The input interface 114 mediates data transmission between the CPU 111 and an input device 118, such as a keyboard and a mouse.

The display controller 115 is connected to a display device 119, and controls display on the display device 119.

The data reader/writer 116 mediates data transmission between the CPU 111 and the recording medium 120, reads out the program from the recording medium 120, and writes the result of processing in the computer 110 to the recording medium 120. The communication interface 117 mediates data transmission between the CPU 111 and another computer.

Specific examples of the recording medium 120 include: a general-purpose semiconductor storage device, such as CF (CompactFlash®) and SD (Secure Digital); a magnetic recording medium, such as a flexible disk; and an optical recording medium, such as a CD-ROM (Compact Disk Read Only Memory).

Note that the information processing apparatus according to the example embodiment can also be realized by using items of hardware such as electronic circuit correspond to the components rather than the computer in which the program is installed. Furthermore, a part of the information processing apparatus may be realized by the program, and the remaining part of the information processing apparatus may be realized by hardware.

A part or an entirety of the above-described example embodiment can be represented by (Supplementary Note 1) to (Supplementary Note 12) described below but is not limited to the description below.

### Supplementary Note 1

An information processing apparatus includes:
a policy analysis unit that analyzes a security policy of operation of a target system;
a dataflow information analysis unit that analyzes dataflow information of the target system; and
an operation procedure construction unit that searches operation procedures registered in advance, using a result of analysis of the security policy, to specify a corresponding operation procedure, and applies a result of analysis of the dataflow information to the specified operation procedure to construct an operation procedure of the target system.

### Supplementary Note 2

The information processing apparatus according to supplementary note 1,
wherein the policy analysis unit extracts information relating to a designated security policy, from among a plurality of security policies registered in advance,
the dataflow information analysis unit extracts information related to the extracted information from the dataflow information, and
the operation procedure construction unit searches the operation procedures registered in advance, using the information extracted from the security policies, to specify an operation procedure corresponding to the designated security policy, and integrates the specified operation procedure and the information extracted from the dataflow information to construct an operation procedure of the target system.

### Supplementary Note 3

The information processing apparatus according to supplementary note 2,
wherein the operation procedure construction unit determines an operation policy of the system, using the information extracted from the security policies, searches the operation procedures registered in advance, using the determined operation policy, to specify an operation procedure corresponding to the designated security policy, and also integrates the determined operation policy to construct an operation procedure of the target system.

### Supplementary Note 4

The information processing apparatus according to supplementary note 3,
wherein the operation policy includes information indicating a level of security required by the system.

### Supplementary Note 5

An information processing method comprising:
analyzing a security policy of operation of a target system;
analyzing dataflow information of the target system; and
searching operation procedures registered in advance, using a result of analysis of the security policy, to specify a corresponding operation procedure, and applying a result of analysis of the dataflow information to the specified operation procedure to construct an operation procedure of the target system.

### Supplementary Note 6

The information processing method according to supplementary note 5,
wherein, in the analysis of the security policy, information relating to a designated security policy is extracted from among a plurality of security policies registered in advance,
in the analysis of the dataflow information, information related to the extracted information is extracted from the dataflow information, and
in the construction of the operation procedure, the operation procedures registered in advance are searched, using the information extracted from the security policies, to specify an operation procedure corresponding to the designated security policy, and the specified operation procedure and the information extracted from the dataflow information are integrated to construct an operation procedure of the target system.

### Supplementary Note 7

The information processing method according to supplementary note 6,
wherein, in the construction of the operation procedure, an operation policy of the system is determined, using the information extracted from the security policies, the operation procedures registered in advance are searched, using the determined operation policy, to specify an operation procedure corresponding to the designated security policy, and the determined operation policy is also integrated to construct an operation procedure of the target system.

### Supplementary Note 8

The information processing method according to supplementary note 7,
wherein the operation policy includes information indicating a level of security required by the system.

### Supplementary Note 9

A computer-readable recording medium including a program recorded thereon, the program including instructions that cause a computer to carry out:
analyzing a security policy of operation of a target system;
analyzing dataflow information of the target system; and
searching operation procedures registered in advance, using a result of analysis of the security policy, to specify a corresponding operation procedure, and applying a result of analysis of the dataflow information to the specified operation procedure to construct an operation procedure of the target system.

### Supplementary Note 10

The computer-readable recording medium of supplementary note 9,
wherein, in the analysis of the security policy, information relating to a designated security policy is extracted from among a plurality of security policies registered in advance,
in the analysis of the dataflow information, information related to the extracted information is extracted from the dataflow information, and
in the construction of the operation procedure, the operation procedures registered in advance are searched, using the information extracted from the security policies, to specify an operation procedure corresponding to the designated security policy, and the specified operation procedure and the information extracted from the dataflow information are integrated to construct an operation procedure of the target system.

### Supplementary Note 11

The computer-readable recording medium according to supplementary note 10,
wherein, in the construction of the operation procedure, an operation policy of the system is determined, using the information extracted from the security policies, the operation procedures registered in advance are searched, using the determined operation policy, to specify an operation procedure corresponding to the designated security policy, and the determined operation policy is also integrated to construct an operation procedure of the target system.

### Supplementary Note 12

The computer-readable recording medium according to supplementary note 11,
wherein the operation policy includes information indicating a level of security required by the system.

Although the invention of the present application has been described above with reference to the example embodiment, the invention of the present application is not limited to the above-described example embodiment. Various changes that can be understood by a person skilled in the art within the scope of the invention of the present application can be made to the configuration and the details of the invention of the present application.

### INDUSTRIAL APPLICABILITY

As described above, according to the present invention, it is possible to support construction of a computer system by presenting a configuration procedure that is in line with a security policy. The present invention is useful in various fields where computer systems with robust security are required.

### REFERENCE SIGNS LIST

10 Information processing apparatus (first example embodiment)
11 Policy analysis unit
12 Dataflow information analysis unit
13 Operation procedure construction unit
20 Operation procedure database
30 Information processing apparatus (second example embodiment)
40 Operation policy database
110 Computer
111 CPU
112 Main memory
113 Storage device
114 Input interface
115 Display controller
116 Data reader/writer
117 Communication interface
118 Input device
119 Display device
120 Recording medium
121 Bus

What is claimed is:

1. An information processing apparatus comprising:
at least one memory storing instructions; and
at least one processor configured to execute the instructions to:
analyze a security policy of operation of a target system;
analyze dataflow information of the target system; and
search operation procedures registered in advance, using a result of analysis of the security policy, to specify a corresponding operation procedure, and apply a result of analysis of the dataflow information to the specified operation procedure to construct an operation procedure of the target system.

2. The information processing apparatus according to claim 1,
wherein the one or more processors further;
extracts information relating to a designated security policy, from among a plurality of security policies registered in advance,
extracts information related to the extracted information from the dataflow information, and
searches the operation procedures registered in advance, using the information extracted from the security policies, to specify an operation procedure corresponding to the designated security policy, and integrates the specified operation procedure and the information extracted from the dataflow information to construct an operation procedure of the target system.

3. The information processing apparatus according to claim 2,
wherein the one or more processors further the determines an operation policy of the system, using the information extracted from the security policies, searches the operation procedures registered in advance, using the determined operation policy, to specify an operation procedure corresponding to the designated security policy, and also integrates the determined operation policy to construct an operation procedure of the target system.

4. The information processing apparatus according to claim 3,
wherein the operation policy includes information indicating a level of security required by the system.

5. An information processing method comprising:
analyzing a security policy of operation of a target system;
analyzing dataflow information of the target system; and
searching operation procedures registered in advance, using a result of analysis of the security policy, to specify a corresponding operation procedure, and applying a result of analysis of the dataflow information to the specified operation procedure to construct an operation procedure of the target system.

6. The information processing method according to claim 5,
wherein, in the analysis of the security policy, information relating to a designated security policy is extracted from among a plurality of security policies registered in advance,
in the analysis of the dataflow information, information related to the extracted information is extracted from the dataflow information, and
in the construction of the operation procedure, the operation procedures registered in advance are searched, using the information extracted from the security policies, to specify an operation procedure corresponding to the designated security policy, and the specified operation procedure and the information extracted from the dataflow information are integrated to construct an operation procedure of the target system.

7. The information processing method according to claim 6,
wherein, in the construction of the operation procedure, an operation policy of the system is determined, using the information extracted from the security policies, the operation procedures registered in advance are searched, using the determined operation policy, to specify an operation procedure corresponding to the designated security policy, and the determined operation policy is also integrated to construct an operation procedure of the target system.

8. The information processing method according to claim 7, wherein the operation policy includes information indicating a level of security required by the system.

9. A non-transitory computer-readable recording medium including a program recorded thereon, the program including instructions that cause a computer to carry out:
analyzing a security policy of operation of a target system;
analyzing dataflow information of the target system; and
searching operation procedures registered in advance, using a result of analysis of the security policy, to specify a corresponding operation procedure, and applying a result of analysis of the dataflow information to the specified operation procedure to construct an operation procedure of the target system.

10. The non-transitory computer-readable recording medium of claim 9,
wherein, in the analysis of the security policy, information relating to a designated security policy is extracted from among a plurality of security policies registered in advance,
in the analysis of the dataflow information, information related to the extracted information is extracted from the dataflow information, and
in the construction of the operation procedure, the operation procedures registered in advance are searched, using the information extracted from the security policies, to specify an operation procedure corresponding to the designated security policy, and the specified operation procedure and the information extracted from the dataflow information are integrated to construct an operation procedure of the target system.

11. The non-transitory computer-readable recording medium according to claim 10,
wherein, in the construction of the operation procedure, an operation policy of the system is determined, using the information extracted from the security policies, the operation procedures registered in advance are searched, using the determined operation policy, to specify an operation procedure corresponding to the designated security policy, and the determined operation policy is also integrated to construct an operation procedure of the target system.

12. The non-transitory computer-readable recording medium according to claim 11,
wherein the operation policy includes information indicating a level of security required by the system.
